(19) United States
(12) Patent Application Publication
(10) Pub. No.: US 2008/0072296 A1
(43) Pub. Date: Mar. 20, 2008

(54) Method for securing sessions between a wireless terminal and equipment in a network

(75) Inventors: Michael Bensimon, Grenoble (FR); Philipe Caloud, Saint-Ismier (FR)

Correspondence Address: PERMAN & GREEN, 425 POST ROAD, FAIRFIELD, CT, 06824, US

(73) Assignee: SOCIETE FRANCAISE DU RADIOTELEPHONE, Paris (FR)

(21) Appl. No.: 11/857,705

(22) Filed: Sep. 19, 2007

(30) Foreign Application Priority Data
Sep. 19, 2006 (FR) 06 08182

(51) Int. Cl. H04L 9/32

(52) U.S. Cl. 726/4

(57) ABSTRACT

The method, to establish a secure session between a wireless terminal (10) and an item of equipment (20) interconnected via a network, includes a prior registration step (50) of the terminal (10) with a RI server distributing user rights in encrypted objects (RO), the registration step enabling the server to record identification data (D) of the terminal and to adapt the terminal to conditions of communication with the server, distribution of a secret to be used by the terminal (10) to establish a session, and the sending of user rights to the terminal, the sent user rights containing permissions to access the equipment (20), the method using an authentication system (A), linking with the server distributing user rights, to authenticate the terminal and generate the secret. The authentication mechanisms provided by the OMA DRM V2 standard can therefore be used to authenticate the terminal (10) and deliver a secret to it.

### FIELD

The disclosed embodiments concern the area of wireless mobile telephony. More specifically, the disclosed embodiments concern a method for setting up a secure session between a wireless communication terminal and an item of equipment in a network.

In the remainder hereof, by terminal is meant any portable transceiver equipment able to operate in a mobile wireless telephony network such as GSM, GPRS, UMTS, CDMA and any type of similar network, e.g. WLAN (Wireless Local Area Network).

### BACKGROUND

In the prior art, the problem of securing exchanges and data processing infrastructures has long been given attention. Up until now, numerous solutions have been proposed, based on known cryptographic technologies. In particular, the infrastructure for managing public keys (<<Public Key Infrastructure>>—PKI) is a solution based on asymmetric key technologies (public key Kp, private key Ks) and is the most developed. A public key Kp corresponds to a sequence of figures used to encode or decode a message transmitted between a transmitter and a receiver, and associated with a paired secret key, also called a private key Ks. The message can therefore be encoded by a public key, known to a group of users, and decoded by a secret key known only to the receiver, or conversely encoded by a private key Ks and decoded by a public key Kp. Whereas encoding with a public key Kp ensures the confidentiality of the message, encoding with a private key Ks ensures its integrity.

This solution, to initialise a secure exchange or to access secured content, provides for the use of public encrypting keys Kp guaranteeing that only the holder of the associated private key Ks is able to decrypt the message, and for the use of certificates securely associating the identity of the partner with the public key Kp, since it is certified (encrypted by a private key Ks) by a certifying authority (“Authentication Centre”=AUC).

In known manner, the authentication centre AUC ensures authentication of the subscribers, and takes part in the confidentiality of data transiting on the wireless interface between the mobile terminal and the base station to which it is attached at a given time.

Nonetheless, the above-mentioned solution is not entirely secure. For example the initialization of the authentication process is a weak point, since there are many certification authorities whose certification policies certainly do not have the same degree of security. The average user has no knowledge thereof, and does not know for example that it may be highly risky to accept certificates certified by some authorities.

Also, the storing of private keys Ks proves to be a problem, especially when it may be in the user's interest to know this key in order to access protected content. The protection of content against pirating must be adapted to cases when the <<attacker>> does not come from the outside but is typically the user himself. Most existing solutions do not take this possibility into account.

The prior art makes provision for securing the mechanisms which distribute digital contents. Therefore, the access to a content can be protected by access rights, for example via technologies of DRM type (<<Digital Rights Management>>). In the latest versions (e.g. the OMA DRM v2 standard by <<Open Mobile Alliance >>), securing comprises initialization and the storing of private keys/certificates in the terminals. This type of securing is adapted to the distribution of content via mobile telephony networks. Also, specific architectures or mechanisms are provided for the various forms of embodiment of mobile terminals available on the market, to limit the risks of pirating private keys particular to the mobile terminals.

Typically, the methods used to distribute secured content apply mechanisms which permit the secure delivering of user rights for protected content (DRM content), as well as keys allowing the content to be decrypted. The <<DRM Specification>> Approved Version 2.0—03 March 2006 OMA-TS-DRM-DRM-V2_{—}0-20060303-A, gives examples of the delivering of these user rights (<<Rights Objects>>—RO).

To set up secure sessions between the terminal and “target” equipment provided with network resources, different security mechanisms can be found:

for GSM/UMTS, mobile terminals are equipped with a security element, the (U)SIM card, which allows identification and authentication of a subscriber via an identifier-symmetric key pair (IMSI-Ki);

for a private network (Virtual Private Network—VPN), the presence of a private key and a certificate on a terminal is frequently used to establish a secure session between the terminal and the equipment;

for Internet access providers, a secure relationship is often established, in WiFi for example, to interconnect an item of access equipment (commonly called the <<box>>) and a terminal.

One drawback of these securing methods is the need to carry out laborious configuration/initialisation procedures so that the specific characteristics of the terminal are taken into account for the session. There is therefore a need for a securing method which guarantees strong authentication of terminals at the time sessions/connections are established, which overcomes the need to master components such as a (U)SIM card or which overcomes laborious configuration procedures such as those implemented for a private VPN network, or to set up a secure link with a <<box>>.

### SUMMARY

The disclosed embodiments aim to eliminate one or more disadvantages of the prior art by determining a method which combines the secure authentication of terminals with simple requesting procedure for connection to equipment (whether this equipment is a server or a connection box [e.g. a box of ADSL or similar type]) allowing access to servers, to a network or to some URL addresses.

For this purpose, the disclosed embodiments concern a method for setting up a secure session between a wireless terminal and equipment interconnected via a network, characterized in that it comprises:

a prior registration step of the terminal with a server delivering user rights in Rights Objects, the registration step enabling the server to record identification data of the terminal and to provide the terminal with elements to adapt to communication conditions with the server,

distribution of a secret to be used by the terminal to establish the session, and the sending of user rights to the terminal, the sent user rights comprising permissions to access the equipment,

the method using an authentication system, linking with the server distributing user rights, to identify the terminal and generate said secret, before a specific communication is set up between the terminal and the server to allow access to the equipment.

The method of the disclosed embodiments therefore advantageously proposes the use of security elements for the management of secured content on terminals, in order to allow secure sessions/connections to be set up between a terminal and an item of equipment. With this method it is therefore possible to guarantee strong authentication of terminals at the time sessions/connections are established, whilst avoiding the need to configure secrets/security elements at the time of initializing the terminal, which are rarely and even never used. Authentication is strong since it reproduces the elements/security mechanisms used for DRM: e.g. a dedicated security microcircuit (chip) embedded in the terminal with a hardened terminal OS.

According to another aspect, to establish a session the method comprises:

a terminal identification step by the authentication system linking with the server, by using terminal identification and terminal authorization data;

a generating step, by the authentication system, of a session key if the terminal identification step is successful, followed by a receiving step of the session key by the terminal;

a generating step in which the server generates a Rights Object protected by means separate from the session key, the Rights Object encapsulating user rights which take into account the terminal characteristics identified by means of the identification data;

a communication step between the terminal and said server, in which the server delivers the Rights Object to the terminal;

an access step by the terminal to the equipment, through use firstly of the session key generated by the authentication system, and secondly of the user rights contained in the Rights Object delivered by the server.

According to another aspect, the method comprises a storage step to store the terminal identification data in memory means available to the authentication system.

According to another aspect, the generation step by the server of a Rights Object is performed following the DRM specifications of the OMA V2 standard.

Therefore, the content distributed, to allow access to the equipment, can be distributed in particular in the form of an encrypted object DCF, protected by a Rights Object (RO) in the meaning of standard OMA V2, and this content is only accessible to the user of the wireless terminal. It will be understood that, with the method of the disclosed embodiments, the authentication and DRM encrypting mechanisms (OMA V2 standard) are used in unique fashion in order to exchange one or more secrets enabling the establishment of one or more secure sessions or connections between one or more terminals and one or more items of equipment.

According to another aspect, the terminal identification step by the authentication system is followed by a communication step between the authentication system and said server, in which the authentication system transmits to the server a unique connection identifier attached to the terminal.

According to another aspect, said communication step between the terminal and said server is initiated by a request step made by the terminal to the server to obtain a Rights Object protected by encrypting, whose key is associated with the terminal.

According to another aspect, said communication step between the terminal and said server is initiated unilaterally by the server to deliver a protected Rights Object associated with the terminal.

According to another aspect, said communication step between the terminal and said authentication server is initiated by a request step made by the terminal and sent to the authentication server.

According to another aspect, said communication step between the terminal and said authentication server is initiated unilaterally by the authentication server to deliver an encrypted object to the terminal.

According to another aspect, the communication step between the terminal and a DRM Proxy server is initiated by a request step made by the terminal to the DRM Proxy server.

According to another aspect, the communication step between the terminal and said DRM Proxy server is initiated unilaterally by the DRM Proxy server to deliver an encrypted object DCF and a Rights Object RO.

According to another aspect, the method of the disclosed embodiments comprises a decrypting step of the Rights Object and of the encrypted object DCF at the terminal, by a cryptographic module of the terminal which was identified by the server during the registration step.

According to another aspect, the method comprises a communication step between the authentication system and said server, in which the authentication system transmits at least one encrypting/decrypting key to the server.

According to another aspect, the encrypted object DCF delivered by the authentication system and the Rights Object RO delivered by the server are received by the terminal and processed by a DRM agent (adapted to standard DRM OMA V2), the access step to the equipment being made after decrypting the encrypted object, DCF, through use of the Rights Object associated with the terminal and the use of a connection module of the terminal for its authentication with the equipment.

According to another aspect, the authentication server inserts at least one encrypting/decrypting key in the encrypted object DCF delivered to the terminal.

According to another aspect, the authentication system transmits to the equipment a URL resource address of a secondary server providing objects carrying a session key, in DCF format, so that a connection module of the terminal is able to send a request to this secondary server for the object in DCF format (carrying the session key) which enables the terminal to access the equipment, the session key being retrieved in decoded form at the terminal after application by a terminal DRM agent of the encrypting/decrypting key.

According to another aspect, the authentication system transmits to the equipment an URL resource address of the server to enable the terminal to perform said registration step by using this URL resource address when a connection request is sent to the equipment.

According to another aspect the terminal, together with the Rights Object, also receives conditions for using the session key (contained in the DCF) e.g. data specifying a validity period of the session key, or a limited number of uses of the session key.

According to another aspect, the authentication server retrieves the terminal characteristics during the step generating the encrypted object DCF to determine and indicate in the encrypted object a type of session that is most suitable for the equipment and for the terminal.

According to another aspect, the method comprises a pairing step to pair the terminal and a box connecting to the network or any other terminal communicating with the network, and thereby domain match several terminals, and a sharing step to share the encrypted object DCF generated by the authentication system and its conditions of use contained in the Rights Object RO.

A further purpose of the disclosed embodiments is to allow a session to be established with equipment of a wireless telephony network, through the use in the wireless communication terminal of a programme able to retrieve the necessary data and to ensure secure authentication of the terminal.

For this purpose, the disclosed embodiments concern a computing programme which can be directly downloaded in an internal memory of a digital processing unit located in a wireless communication terminal, able to communicate with a wireless telephony network, the terminal comprising means to store terminal identification data, characterized in that it comprises portions of software codes to perform the following steps when said programme is run by the digital processing unit:

deliver and transmit identification data, to enable the terminal to identify itself with a network authentication system;

receive a Rights Object issued by a server distributing protected user rights,

receive an encrypted object delivered by an authentication server distributing authentication secrets,

trigger decrypting, by a DRM agent, of the encrypted object by means of the Rights Object,

extract user rights from the encrypted object which contain permissions to access an item of equipment of the network,

extract from the data received via the network at least one secret generated by the authentication system, by use of the DRM agent,

use said secret (as session key) and the user rights to establish a secure session between the wireless terminal and the network equipment.

### BRIEF DESCRIPTION OF THE DRAWINGS

The disclosed embodiments, with its characteristics and advantages will become more clearly apparent on reading the description made with reference to the appended drawings given as non-limiting examples, in which:

FIG. 1 shows a first example of the sequence flow of the method according to the disclosed embodiments,

FIG. 2 illustrates a second example of the sequence flow of the method according to the disclosed embodiments,

FIG. 3 is a schematic of one embodiment of the method used by the terminal to obtain the secrets required to establish a secure session with an item of network equipment.

### DETAILED DESCRIPTION OF PREFERRED EMBODIMENTS

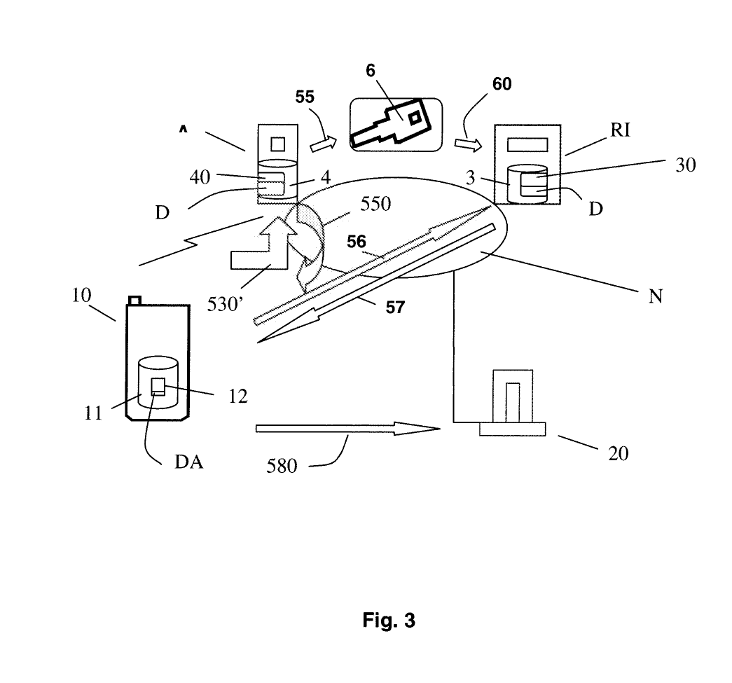

With reference to FIG. 3, the wireless communication terminal 10 can be equipped with a DRM agent which ensures a high level of security. This DRM agent may advantageously conform fully to OMA version 2 standard (Open Mobile Alliance) and includes at least one cryptographic module 12. In one embodiment the DRM agent supports flexible use models such as content sharing. It allows the secure providing and management of content such as music and video in the mobile domain. Advantageously, this DRM agent can be used by a connection programme or module of the terminal 10 in charge of exploiting the secrets and user rights retrieved via the network N, this programme thereby making it possible to manage the establishing of the secure session between the wireless terminal 10 and the equipment 20.

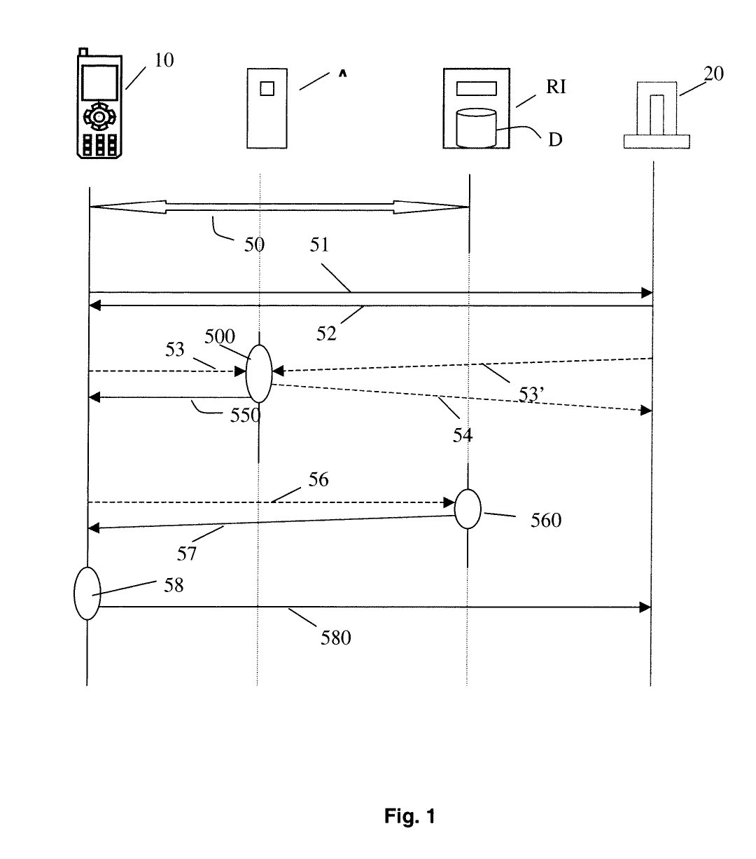

The disclosed embodiments are described below with reference to FIGS. 1, 2 and 3.

The registration step 50 of the terminal 10 with the Rights Issuer server RI distributing user rights, enables the RI server to record the identification data D of the terminal 10. The RI server therefore manages a list of previously registered wireless terminals 10 so that these terminals are able to receive user rights issued by this RI server. The registration step 50 also enables the terminal 10 to be adapted to communication conditions with the RI server by providing the terminal with adaptation elements: the configuration of the terminal 10 can therefore be adjusted, the server also being able to adapt itself to communication conditions to allow exchanges with the terminal 10. Open Mobile Alliance (OMA) defines a mode called <<4-th path registration protocol>> which enables the terminal 10 to register with a Rights Issuer RI. After this phase, the terminal 10 is able to obtain secrets in secure manner, for example via a data item protecting sensitive content, which is called DCF under the OMA V2 standard. In the method of the disclosed embodiments, the mechanisms for reading encrypted objects DCF can be used not to access protected content (this content being conveyed in DCF data) but to transmit data (e.g. a secret and an identifier) allowing a secure session to be set up with at least one item of equipment 20. The communication conditions, as indicated in the DRM specification of OMA Alliance (Version 2), comprise for example the protocol parameters, the protocol version to be used, the cryptographic algorithms, certificate exchange preferences, optional certificate exchange, mutual authentication of the terminal 10 and server RI, protected integrity of protocol messages and time synchronization of an optional DRM device.

These various communication conditions are known per se by persons skilled in the art (cf. “DRM Specification>> Approved Version 2.0—03 March 2006, OMA) and will not be detailed herein.

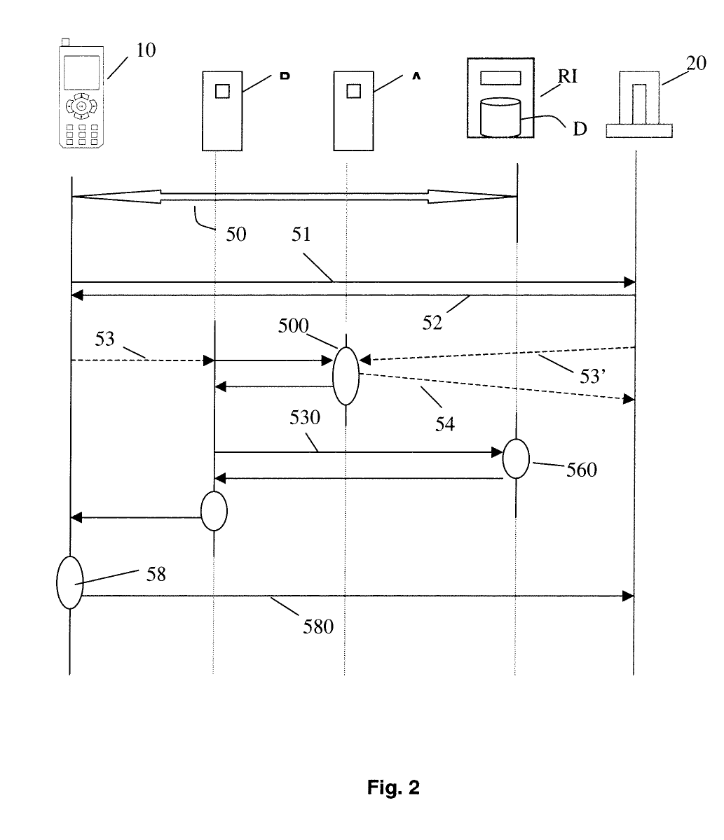

To allow the establishment of a secure session between a wireless terminal 10 and an item of equipment 20 interconnected via a network N, the method comprises the following, as illustrated in particular FIGS. 1 and 2:

the prior registration step 50 of the terminal 10 with a RI distributing user rights in Rights Objects RO,

distribution of a secret to be used by the terminal 10 to establish a session, and the sending of user rights to the terminal 10, the sent user rights containing permissions to use the secret and hence to access the equipment 20, and

specific use of an authentication system A, linking with the RI server distributing user rights, to identify the terminal 10 and generate said secret.

It will be understood that the RI server is in charge of registering the terminal 10 and distributing Rights Objects RO to it. The authentication system A is therefore in charge of generating the secret which will allow authentication of the terminal 10 at the time of its session/connection to the equipment 20, and to distribute the secret to the terminal via a DCF. The secret may consist of a session key which may also be distributed to the equipment 20 by the authentication system A in an optional step 54. It is also possible in this optional step 54 to make provision for the distribution of a public key associated with the secret given to the terminal 10. Hereunder, by session key is meant a private key Kc in an encrypting process which may or may not be asymmetric, or any other similar secret data allowing a secure session/connection to be established.

Compared with the DRM mechanisms of the OMA V2 standard, the method of the disclosed embodiments allows reuse of the security elements (of the terminal and of the network [RI and optionally DRM Proxy server P]) used for management of secured content on terminals, in order to enable the establishing of secure sessions/connections between the terminal 10 and an item of equipment 20. It is therefore able to guarantee strong authentication of the terminals when session/connections are established, whilst overcoming the need for mastering of components such as a (U)SIM card or the need for laborious configuration procedures such as those which have to be carried out for a VPN network, or in order to set up a secure link with a <<box>>.

In one embodiment, the establishment of the secure session/connection between the item of equipment 20 and the requesting wireless communication terminal 10 is based on authentication mechanisms provided in the OMA DRM v2 standard, in order to identify or authenticate the terminal 10 and to distribute a secret to it, e.g. a session key Kc, and optionally additional data such as a validity period of said Kc key permitting the establishment of the secure session/connection. The authentication system A may also, either alternatively or in addition, use a mechanism to restrict the use of secrets to a limited number of times.

With reference to FIG. 2, it will be appreciated that the terminal 10 may simultaneously, via a DRM Proxy server P, receive a Rights Object RO generated by the RI server during step 560 as well as an encrypted object (DCF) generated by the authentication server A during a generation step 500 with forming of the encrypted object DCF which encapsulates the session key for the session between the terminal 10 and the item of equipment 20. One advantage of delivering the secret via the server P is to minimize interactions of the terminal 10 with a plurality of items of equipment (here the server A and server RI). As in FIG. 1, the server A retrieves the characteristics of terminal 10 during step 500 generating the encrypted object DCF, to determine and indicate in the encrypted objected DCF a type of session that is most suitable for the equipment 20 and for the terminal 10.

With reference to FIG. 1, to establish the session the methods comprises for example:

an identification step 540 to identify the terminal 10 by the authentication system A linking with the RI server, through the use of terminal identification data D and terminal 10 authorization data DA (the authorization data also possibly being communicated to the terminal);

a generation step 500 by the authentication system A to generate a session key if the terminal identification step 540 is successful, followed by a receiving step 550 by the terminal 10 of the session key protected via a DCF object;

a generation step 560 by the RI server of a Rights Object RO encapsulating user rights which take into account the characteristics of the terminal 10 identified using the identification data D;

a communication step 57 between the terminal 10 and said RI server in which the RI server delivers the Rights Object RO to the terminal 10;

an extraction step 58 by the terminal 10 to extract from the DCF the session key generated by the authentication system A, by means of a DRM Agent, and the Rights Object RO delivered by the RI server;

an access step 580 to the equipment 20 by the terminal 10 using the session key extracted during step 58;

Therefore, in the example shown FIGS. 1 and 2, the terminal 10 can receive the secret in the form of a standard object containing protected information, called a DCF (for DRM Content Format). This information is encrypted for example by one or more keys which are sent separately in an object which itself is encrypted by public and private keys, this object forming a <<Rights Object>> (RO) in accordance with the DRM OMA V2 standard. With reference to FIG. 1, when receiving a request 53, the authentication system A supplies the terminal 10 with a DCF content (step 550) containing the required secret(s), this content being encrypted for example by means of a key K. In parallel, the authentication system A may also provide a secret or key associated with the secret distributed to the terminal 10, which enables the equipment 20 to authenticate this terminal as illustrated by step 54. It is the RI server which ensures distribution of user rights for digital content. The RI server may also distribute the session key or keys allowing the content to be decrypted, via the sending of said encrypted objects RO or protected information DCF. In other words, the authentication server A provides the terminal with the secret(s) in the form of an encrypted object DCF, which is completed by the associated Rights Object provided by the RI server.

Whereas delivering of the protected information DCF and of the Rights Object RO is made in combined manner in the example in FIG. 2, it could be considered that this delivering is made separately as illustrated FIG. 1. In this case the request step 53 made by the terminal 10 only concerns the encrypted object DCF carrying the session key and the Rights Object RO for user rights. It is also to be understood that step 53 initiated by the terminal 10 to request a session key generated by the authentication system A may be replaced by a request step 53′ made by the equipment E which makes it possible to reduce the communication time.

According to one embodiment the equipment 20 may itself act as DRM Proxy server P as illustrated FIG. 2.

In one embodiment, the protected information may be distributed by a secondary server providing objects in DCF format. In this case, the authentication system A may for example transmit to the equipment 20 a URL resource address or name of the secondary server (containing the secrets and unique identity of the connection) supplying objects in DCF format, carrying a session key. The equipment 20 sends this information to the terminal 10. Therefore a connection module of the terminal can then request this secondary server for the object in DCF format carrying the session key which will enable the terminal 10 to access the equipment 20, the session key being retrieved in decoded form at the terminal 10 after a DRM Agent of the terminal 10 has used the key 6 allowing decrypting of the protected information DCF, this encrypting/decrypting key 6 being given in the Rights Object RO. In other words, step 57 in which the Rights Object RO is sent, as illustrated FIG. 2, in this case allows the delivering of at least one encrypting/decrypting key 6 which is needed by the decrypting module 12 of the terminal 10 to extract an exploitable content from the protected information DCF.

In the embodiments shown FIGS. 1 and 2, the authentication system A transmits the encrypting/decrypting key 6 during the communication step 55 with the RI server, so that the RI sends this key 6 via a protected Rights Object RO. With reference to FIG. 3, the retrieval 60 of this encrypting/decrypting key 6 generated and stored by the authentication system A, may be made after a request 530 by the RI server to retrieve this encrypting/decrypting key 6. The encrypting/decrypting key 6 may be replaced by any other key(s) or confidential data to protect the content of the DCF information.

Step 53 corresponds to a request sent by the terminal to the authentication server A to obtain the secret(s) enabling it to set up the secured connection or session with the equipment. These secrets, once generated in step 500, become a content to be processed in accordance with the DRM specifications of standard OMA V2. In other words, step 560 generating the Rights Object RO and/or DCF information corresponds to an extension of the field of application of DRM technology, and the usual associated architecture. For this purpose, the method of the disclosed embodiments uses a new link between the DRM architecture entity which distributes a user right to a user's terminal/set of terminals, i.e. the RI server, with an authentication system A linked to an access gateway to a communication service which manages sessions established via the network N with the equipment 20.

With reference to FIGS. 1 and 2, when there is attempted access 51 by a user's terminal 10 to a service requesting the establishing of a connection (session) to an item of equipment 20, this equipment 20 indicates to the terminal 10 in a first automatic reply 52 that it needs a secret or secrets to set up a secure connection or session. In one embodiment, the equipment 20 may optionally indicate in this reply 52 the authentication server A which distributes user rights and/or a suitable secondary server to deliver the adequate Rights Object and/or DCF information. For example, the authentication system A is adapted to transmit to the equipment 20 a URL resource address of the RI server, to then enable the terminal 10 to carry out the registration step 50 using this URL resource address when sending a request for connection to the equipment 20.

The terminal then submits a request 53 to the authentication server A which provides it with the secret. It will be appreciated that this system A can easily be co-located with the RI server or with the equipment 20.

The decrypting step 58, in particular of the encrypted DCF object, may be made at the terminal 10 which has all the necessary elements to extract the protected data. These protected data contain the session key or keys for example, the user rights and a certificate and/or a unique identifier for connection to the equipment 20. The terminal 10 has a cryptographic module 12, which was identified by the RI server during registration step 50, to extract these protected data. The access step 580 to the equipment 20 is made after decrypting the encrypted object DCF and use of a connection module of the terminal 10 for its authentication vis-a-vis the equipment 20. In one embodiment, a communication step 55 between the authentication system A and the RI server, following after the identification step 540 of the terminal 10, comprises the transmission to the RI server of a unique connection identifier attached to the terminal 10. The transmission of this connection identifier to the RI server may, but is not limited thereto, be made at the same time as the transmission of the secret to be subsequently delivered with the encrypted object DCF.

Generation step 500, in which the encrypted object DCF is generated by the authentication server A, advantageously takes into account the characteristics and hence the specific operating functions of the terminal 10. It is also pointed out that this authentication system A allows a certificate to be delivered to the terminal to establish the session, which is unique. Therefore this type of certificate may be related unique fashion to the user's identity (typically the MSISDN).

In the example in FIG. 1, said communication step 57 between the terminal 10 and the RI server is initiated by a request step 56 sent by the terminal 10 to the RI server for the Rights Object RO. With reference to FIG. 1, communication step 57 between the terminal 10 and said RI server may be initiated unilaterally by the RI server to deliver the Rights Object RO associated with the terminal 10 and with the DCF.

Similarly, in the examples of FIGS. 1 and 2, the distribution of the DCF to the terminal 10 is initiated by a step 53 to distribute the secret to the terminal 10. With reference to FIGS. 1 and 2, steps 57 and 550 can be initiated unilaterally by the authentication server A or by the DRM Proxy server (P).

Step 53′ corresponds to a request for the delivering of this encrypted object DCF and of the Rights Object RO, initiated by equipment 20 which has just received a request from the terminal 10. In the embodiment shown FIG. 2, applying this mechanism, the equipment 20 is in charge of transmitting the identification data to the authentication server A.

In a preferred embodiment, the network N linking the RI server, the authentication server A and the terminal 10, is a network managed by a wireless telephony operator, the terminal 10 therefore being able to communicate at least with the RI server and with the authentication server A for any location served by the network N. With reference to FIG. 3, the method provides for a data storage step to store identification data D of the terminal 10 in memory means 4 available to the authentication system A. This identification data D, in combination with the authorization data DA provided by the terminal 10, allow identification by the authentication system A. The identification module 40 of system A, stored in the memory means 4 of system A, allows comparison between received data with expected data, and the generation of session keys and of DCF. If they match, the terminal 10 is identified and can receive the required secret elements to open a session with the equipment 20.

The authorization data (DA) are stored in a memory 11 of the terminal 10 and include for example a certificate or an authentication key related to the user and/or the terminal 10. The RI server and authentication system A have, for example, the same identification data D of terminal 10 so that they are able to conduct tasks separately having regard to the characteristics of the terminal 10, these tasks enabling the protected delivery to the terminal 10 of the elements needed for establishing a secure session/connection with the equipment 20 of network N. The memory means 3 of the RI server are used to store in particular the identification data D of terminals, e.g. in the form of tables listing the characteristics of each terminal 10. The generating model 30 generating Rights Objects RO, and optionally a module generating protected information of DCF type, may be stored in the memory means 3 of the RI server.

In one embodiment, the equipment (20) may be accessed by the terminal 10 via a short-distance connection (<<Bluetooth>>, infrared, WiFi, etc.), without passing through the network N. In one first case, the terminal 10 uses the network N to retrieve the elements necessary for setting up the connection, such as the Rights Object RO delivered by the RI server. Alternatively, the equipment 20 which has access to a network may act as DRM Proxy (P) and therefore the terminal 10 does not need to use the network N.

<<Domain>> certificates can be generated by the RI server so that a group of terminals 10 can be associated together and have the same rights, since they belong for example to one same user. To minimize interactions between terminals 10 and the available RI and A servers of a network N, for the delivery of user rights, a group of <<terminals>> can be domain matched. Therefore if, for example, ten or so terminals are domain matched, when one of the terminals has obtained the secret(s) enabling it to access an item of equipment 20, this terminal can transmit the secret or secrets to the other nine terminals in accordance with conventional transmission mechanisms for DCF and Rights Objects in a DRM domain. Any one of the nine other terminals is therefore able to set up a secure session or connection with the equipment 20 with no additional request to a RI server distributing Rights Objects RO in the meaning of standard DRM OMA V2 architecture. Mechanisms to domain match equipment are described in the OMA DRM V2 specifications.

In this way, users can for example domain match their mobile terminal 10 with their connection box (distributed by an Internet access provider) which forms a second terminal. Subsequently, the box will be able to transmit the secret(s) obtained from server A and the Rights Objects RO obtained from the RI server to the mobile terminal 10, and a user can have connection rights to an item of equipment 20 for a group of referenced terminals.

In this mode, and so as to limit the resources allocated by the box, the box can limit non-secured equipment connections to a closed list. The box may only allow those terminals to access the network N which are able to set up a secure session/connection with one or more items of equipment, and may restrict requests to a limited group of equipment items. It is to be noted that in the above-mentioned example, the box itself may be considered as the equipment 20.

So that it can support a class of terminals for which multiple mechanisms of secure connections/sessions may be implemented, the authentication server A may advantageously indicate the type of secure connection/session which is the most suitable for the equipment 20 and for the terminal 10 under consideration. The advantage of identifying the terminal 10 is to have exact knowledge of its characteristics, and hence optionally to send parameters specific to this class of terminals at the time of request for a connection/session.

In the example of a mobile wireless communication terminal, wishing to access various network resources via connection boxes distributed by an Internet access provider, the terminal 10 must firstly register with a RI distributing Rights Objects. The terminal 10 must also register with an authentication server A. The terminal 10 under consideration is associated with a subscription to an Internet access provider. When the terminal 10 attempts to access an item of equipment 20 via one of the boxes of said provider, the equipment 20 indicates to it that it must obtain secrets from the indicated authentication server A. The terminal 10 then sends a request to server A to obtain at least one secret enabling it to open a secured connection or session with the equipment 20. On receipt of the secret (via the DCF) and of the Rights Object, the terminal 10 is able to open a secure session or connection with the equipment 20.

One of the advantages of the method according to the disclosed embodiments is that it is not based on a static certification mechanism of the terminal 10, in which all the elements needed are pre-recorded in the terminal 10. On the contrary, the described method proposes dynamic certification of the terminal, using the network N as dynamic certifying tool: if the terminal 10 is indeed the terminal it purports to be, it must be capable not only of successfully passing identification step 540, but also it must be capable of exploiting the protected information delivered by a RI server having knowledge of the specific characteristics of the authorized terminal 10. For example, the connection software of the authorized terminal 10 knows firstly how to contact the servers A and RI after receipt of the reply from the equipment 20, to obtain the DCF and associated RO, and secondly how to use the secrets contained in the encrypted object DCF so that it can authenticate itself with the equipment 20 and its authentication server. Additionally, the connection software of the terminal 10 may optionally encrypt the connection to the equipment 20.

It is to be appreciated that the disclosed embodiments are not limited only to a mere extension of the use of usual DRM agents available in mobile terminals 10. According to the method of the disclosed embodiments, the secret which is used to authenticate/identify the terminal 10 at the time of its access to an item of equipment 20 can be considered as content distributed by mechanisms of DRM V2 type (DRM Specification, OMA V2).

The applications of the disclosed embodiments are multiple. For example in a DRM application, the terminal 10 cannot transmit its specific user rights and session key(s) to the equipment 20 without having been first identified via the network N. Also, the characteristics of the terminal 10 are truly taken into account. When an application of the terminal 10 requests access to equipment 20, it can consult the authentication system A which will identify the terminal 10 and provide the necessary elements with the support of the RI server. Whereupon, since the RI server shares a secret with the terminal 10, the user rights of the keys can be transmitted in operational and secured manner via a Rights Object RO and a DCF data item.

Also, the DCF content and the Rights Object RO can be sent proactively to the terminal 10, which minimizes the time for establishing a connection/session with the equipment 20. It is also to be noted that the method of the disclosed embodiments can also be implemented for the sole purpose of allowing authentication of a terminal/client.

The use of the RI server available via the network N and of the authentication system A according to the disclosed embodiments can also permit the providing of preferential rights on an item of equipment 20 in relation to the identification of the terminal 10 and its type. Therefore in the example in which the equipment 20 is a connection box of the Internet access provider, the box may authorize a terminal 10 to access to limited resources (e.g. solely the authentication system A and RI server with the HTTP protocol). After authentication, the box can then provide a level of preferential rights adapted to the terminal 10, such as also allowing this terminal 10 to carry out vocal calls via the network N.

It will be obvious for persons skilled in the art that the disclosed embodiments allow embodiments in numerous other specific forms without departing from the area of application of the disclosed embodiments such as claimed. Therefore, the embodiments described herein are to be considered illustrations which may be modified in the area defined by the scope of the appended claims, and the disclosed embodiments are not to be construed as being limited to the above-described details.

1. Method to establish a secure session between a wireless terminal (10) and an item of equipment (20) interconnected via a network (N), comprising:
a prior registration step (50) of the terminal (10) with a Rights Issuer server (RI) distributing user rights in Rights Objects (RO), the registration step (50) enabling the RI server to record identification data (D) of the terminal (10) and to provide the terminal with elements to adapt to communication conditions with the RI server,
distribution of a secret to be used by the terminal (10) to establish the session, and sending of user rights to the terminal (10), the sent user rights containing permissions to access the equipment (20),
the method using an authentication system (A), linking with the RI server distributing user rights, to identify the terminal (10) and generate said secret, before a specific communication is set up between the terminal (10) and the RI server to allow access to the equipment (20).

2. Method according to claim 1 comprising, in order to establish the session:
an identification step (540) of the terminal (10) by the authentication system (A) linking with the RI server, through use of identification data (D) and authorization data (DA) of the terminal (10);
a generation step (500) by the authentication system (A) to generate a session key if the identification step (540) of the terminal (10) is successful, followed by a receiving step (550, 57) by the terminal (10) of the session key;
a generating step (560) by the RI server of a Rights Object (RO) protected by means separate from the session key, the Rights Object (RO) encapsulating user rights which take into account the characteristics of the terminal (10) identified by means of the identification data (D);
a communication step (57) between the terminal (10) and said RI server, in which the RI server delivers the Rights Object (RO) to the terminal (10);
an access step (580) to the equipment (20) by the terminal (10), through use firstly of the session key generated by the authentication system (A) and secondly of the user rights contained in the Rights Object (RO) delivered by the RI server.

3. Method according to claim 1, comprising a storage step to store identification data (D) of the terminal (10) in memory means (4) available to the authentication system (A).

4. Method according to claim 2, wherein the generating step (560) by the RI server of a Rights Object (RO) is performed according to the DRM specifications of the OMA V2 standard.

5. Method according to claim 2, wherein said identification step (540) of the terminal (10) is followed by a communication step (55) between the authentication system (A) and said RI server, in which the authentication system (A) transmits to the RI server a unique connection identifier attached to the terminal (10).

6. Method according to claim 2, wherein said communication step (57) between the terminal (10) and said RI server is initiated by a request step (56) sent by the terminal (10) to the RI server to obtain a Rights Object (RO) protected by encrypting whose key is associated with the terminal (10).

7. Method according to claim 2, wherein said communication step (57) between the terminal (10) and said RI server is initiated unilaterally by the RI server to deliver a protected Rights Object (RO) that is associated with the terminal.

8. Method according to claim 2, wherein said communication step (550) between the terminal (10) and said authentication server (A) is initiated by a request step (53) sent by the terminal (10) to the authentication server (A).

9. Method according to claim 2, wherein said communication step (550) between the terminal (10) and said authentication server (A) is initiated unilaterally by the authentication server (A) to deliver an encrypted object (DCF) to the terminal.

10. Method according to claim 2, wherein said communication step between the terminal (10) and a DRM Proxy server (P) is initiated by a request step (53) sent by the terminal (10) to the DRM Proxy server (P).

11. Method according to claim 2, wherein the communication step between the terminal (10) and said DRM Proxy server (P) is initiated unilaterally by the DRM Proxy server (P) to deliver an encrypted object (DCF) and a Rights Object (RO).

12. Method according to claim 1, comprising a decrypting step (58) of the Rights Object (RO) and of the encrypted object (DCF) at the terminal (10), by a cryptographic module (12) of the terminal (10) which was identified by the RI server during the registration step (50).

13. Method according to claim 1, comprising a communication step (55) between the authentication system (A) and said RI server, wherein the authentication system (A) transmits at least one encrypting/decrypting key (6) to the RI server.

14. Method according to claim 2, wherein the encrypted object (DCF) delivered by the authentication server (A) and the Rights Object (RO) delivered by the RI server are received by the terminal (10) and processed by a DRM agent, the access step (580) to the equipment (20) being carried out after decrypting the encrypted object (DCF) through use of the Rights Object associated with the terminal, and the use of a connection module of the terminal (10) for authentication with the equipment (20).

15. Method according to claim 2, wherein the authentication server (A) inserts in the encrypted object (DCF) delivered to the terminal (10) at least one encrypting/decrypting key (6).

16. Method according to claim 15, wherein the authentication system (A) transmits to the equipment (20) a URL resource address of a secondary server providing objects in DCF format, carrying session keys, so that a connection module of the terminal (10) is able to request from this secondary server the object in DCF format carrying the session key to allow the terminal (10) to access the equipment (20), the session key being retrieved in decoded form at the terminal (10) after use by a DRM agent of the terminal (10) of the encrypting/decrypting key (6).

17. Method according to claim 1, wherein the authentication system (A) transmits to the equipment (20) a URL resource address of the RI server to enable the terminal (10) to perform said registration step (50) using this URL resource address when requesting a connection to the equipment (20).

18. Method according to claim 2, wherein the terminal (10) receives the Rights Object (RO) together with the conditions of use of the session key as well as data specifying the period of validity of the session key.

19. Method according to claim 2, wherein the terminal (10) receives the Rights Objects (RO) together with the conditions of use of the session key and data specifying a limited number of uses of the session key.

20. Method according to claim 2, wherein the authentication server (A) retrieves the characteristics of the terminal (10) during step (500) generating the encrypted object (DCF) to determine and indicate in the encrypted object (DCF) a type of session most suitable for the equipment (20) and for the terminal (10).

21. Method according to claim 2, wherein the identification step (540) is made with an authentication system (A) co-located with the RI server.

22. Method according to claim 2, wherein the identification step (540) is made with an authentication system (A) co-located with the equipment (20).

23. Method according to claim 1, comprising a pairing step between the terminal (10) and a box connecting to the network (N) or another terminal communicating with the network (N) to domain match several terminals, and a step to share the encrypted object (DCF) generated by the authentication system (A) and its conditions of use contained in the Rights Object (RO).

24. Computing programme directly downloadable into an internal memory of a digital processing unit located in a wireless communication terminal (10) able to communicate with a wireless telephony network (N), the terminal comprising storage means (11) to store identification data (D) of the terminal (10), characterized in that it comprises portions of software codes to perform the following steps when said programme is run by the digital processing unit:
deliver and transmit identification data (D), to enable the terminal (10) to identify itself with an authentication system of the network (N);
receive a Rights Object (RO) issued by a RI server distributing protected user rights;
receive an encrypted object (DCF) issued by an authentication server (A) distributing authentication secrets;
trigger decrypting by a DRM agent of the encrypted object (DCF) using the Rights Object (RO);
extract, from the encrypted object (DCF), the user rights containing permissions to access an item of equipment (20) of the network (N);
extract from data received via the network (N) at least one secret generated by the authentication system, using the DRM agent;
use said secret and the user rights to establish a secure session between the wireless terminal (10) and the equipment (20) of the network.
